(19) United States
(12) Patent Application Publication
(10) Pub. No.: US 2012/0162061 A1
(43) Pub. Date: Jun. 28, 2012

(54) ACTIVATION OBJECTS FOR INTERACTIVE SYSTEMS

(75) Inventors: Peter W. Hildebrandt, Duluth, GA (US); Neal A. Hofmann, Atlanta, GA (US); Brand C. Kvavle, Tigard, OR (US)

(73) Assignee: Polyvision Corporation, Suwannee, GA (US)

(21) Appl. No.: 13/168,651

(22) Filed: Jun. 24, 2011

Related U.S. Application Data
(60) Provisional application No. 61/358,800, filed on Jun. 25, 2010.

(51) Int. Cl. G09G 5/00

(52) U.S. Cl. 345/156

(57) ABSTRACT

An interactive system can include a display device, a control panel, a projector, a processing device, and an input device. The input device can detect indicia of its posture relative to the control panel or a display surface of the display device, so that the interactive system can recognize interactions between the input device and these components. Interactions between the input device and the display surface can be captured, analyzed by the processing device, and then represented in an image projected onto the display surface. The control panel can comprise a plurality of non-projected, tactile activation objects, each of which can correspond to an activity or function of the interactive system, such as, for example, powering on the projector. When the interactive system detects an interaction between the input device and an activation object, the activity corresponding to the selected activation object can be performed.

### CROSS-REFERENCE TO RELATED APPLICATIONS

This application claims a benefit, under 35 U.S.C. §119(e), of U.S. Provisional Application Ser. No. 61/358,800, filed 25 Jun. 2010, the entire contents and substance of which is hereby incorporated by reference.

### TECHNICAL FIELD

Various embodiments of the present invention relate to interactive systems and, more particularly, to activation objects configured to drive various components of interactive systems.

### BACKGROUND

Electronic display systems, such as electronic whiteboard systems, are steadily becoming a preferred alternative to traditional whiteboard and marker systems. Unfortunately, a major drawback of electronic display systems is that they incorporate various distinct electrical components that must be operated individually in order to use the electronic display system. Thus, a user must travel back and forth between the computer, the display, and peripherals to operate the electronic display system as desired.

For example, to turn on a projector of an electronic display system, the user must travel to the projector and flip a switch or push a button. Other components that need to be turned on individually include, for example, an audio system. Even when all components are powered up, adjustments may need to be made, such as volume changes source input, and projector screen positioning, which can also require the user to travel inconveniently about the room to adjust the various components and the operating characteristics of the electronic display system.

### SUMMARY

Various embodiments of the present invention relate to activation objects for interactive systems, such as electronic display systems. In an interactive system, an activation object can be a non-projected, detectable object that can initiate a predetermined activity of the interactive system. For example and not limitation, activation objects can initiate powering components on or off, focusing a projector, raising or lowering a projector screen, or adjusting the volume of an audio system.

According to some exemplary embodiments of the present invention, an interactive system can comprise a display device, a plurality of activation objects, a projector, a processing device, and an input device.

For instance, general operation of the interactive system includes interactions between the input device and a display surface of the display device that can be captured, analyzed by the processing device, and then represented in an image projected onto the display surface. Thus, interactions between the input device and the display surface can be displayed and digitally captured for present or future use. Alternatively, interactions can drive an aspect of the processing device, e.g., can drive software.

An activation object can be a detectable object corresponding to a particular activity of the interactive system. The interactive system can determine whether the posture of the input device is such that the input device is interacting with an activating object. When the interactive system detects an interaction between the input device and a particular activation object, the interactive system can perform the activity corresponding to that activation object. In an exemplary embodiment, the activation objects are non-projected images and remain visible and detectable even when most or all of the components of the interactive system are powered down to stand-by or off states. Thus, in some embodiments, the activation objects can be used to initiate activities related to powering on devices. For example and not limitation, an interaction between the input device and a first activation object can initiate powering on the projector.

In some embodiments, an activation object can be or comprise an icon or text representing the activity corresponding to the activation object. Thus, a user of the interactive system can select the icon representing the desired activity, and in response to the selection, the interactive system can perform the activity corresponding to the activation object that comprises the selected icon.

These and other objects, features, and advantages of the mounting system will become more apparent upon reading the following specification in conjunction with the accompanying drawing figures.

### BRIEF DESCRIPTION OF THE FIGURES

FIG. 1 illustrates a diagram of an interactive system, according to an exemplary embodiment of the present invention.

FIG. 2 illustrates a front view of a control panel of the interactive system, according to an exemplary embodiment of the present invention.

FIG. 3A illustrates a partial cross-sectional side view of a capped input device of the interactive system, according to an exemplary embodiment of the present invention.

FIG. 3B illustrates a partial cross-sectional side view of the input device without a cap, according to an exemplary embodiment of the present invention.

FIG. 4A illustrates a partial cross-sectional side view of the input device without a cap, according to an exemplary embodiment of the present invention.

FIGS. 4B-4C illustrate partial cross-sectional side views of the input device with a cap, according to exemplary embodiments of the present invention.

FIGS. 5A-5C illustrate various images of a dot pattern, as captured by a sensing device of the input device, according to an exemplary embodiment of the present invention.

FIG. 6 illustrates a use of the input device in conjunction with a display surface of the interactive system, according to an exemplary embodiment of the present invention.

FIG. 7 illustrates a second use of the input device in conjunction with an activation object of the interactive system, according to an exemplary embodiment of the present invention.

### DETAILED DESCRIPTION

To facilitate an understanding of the principles and features of the invention, various illustrative embodiments are explained below. In particular, the invention is described in the context of being activation objects for powering and adjusting components of an electronic display system. Embodiments of the invention, however, are not limited to these embodiments. Rather, various aspects of the present invention can perform other functions besides powering and adjusting and need not be limited to electronic display systems.

The materials and components described hereinafter as making up elements of the invention are intended to be illustrative and not restrictive. Many suitable materials and components that would perform the same or similar functions as the materials and components described herein are intended to be embraced within the scope of the invention. Other materials and components not described herein can include, but are not limited to, for example, similar or analogous materials or components developed after development of the invention.

Various embodiments of the present invention can include activation objects and interactive systems utilizing activation objects. Referring now to the figures, in which like reference numerals represent like parts throughout the views, various embodiment of the activation objects and interactive system will be described in detail.

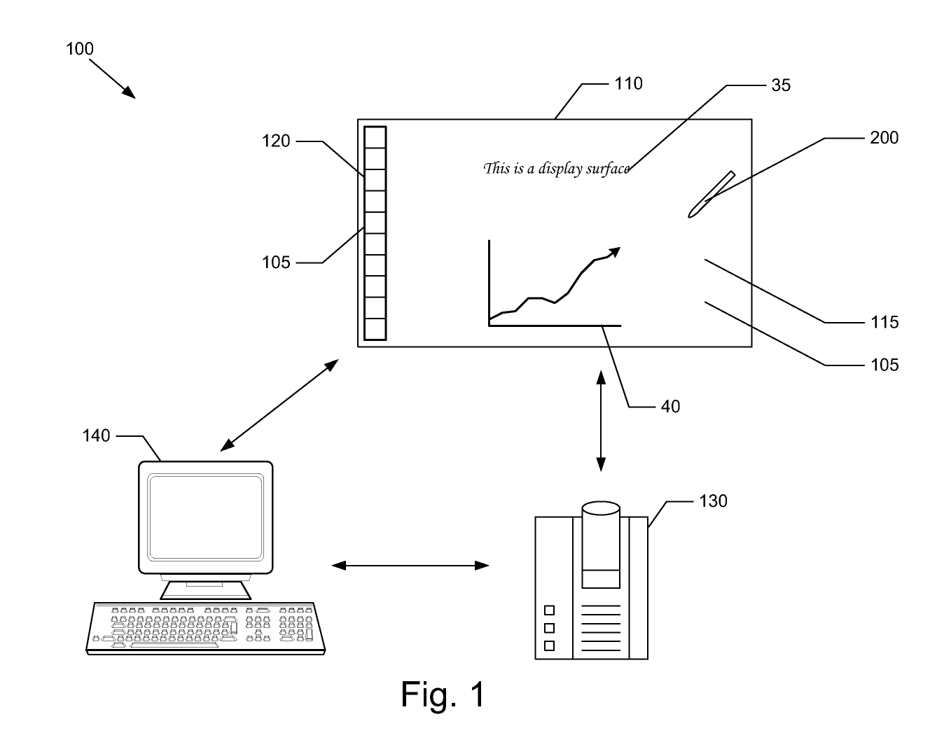

FIG. 1 illustrates a diagram an interactive system 100, according to an exemplary embodiment of the present invention. As shown, the interactive system 100 can comprise a display device 110, a control panel 120, a projector 130, a processing device 140, and an input device 200. In general, interactions between the input device 200 and a display surface 115 of the display device 200 can be captured, analyzed by the processing device 140, and then represented in an image projected onto the display surface 115. These interactions can be digitally captured for present or future use, such as displaying, printing, or editing.

The interactive system 100 can detect interactions between the input device 200 and various detectable objects 105 of the interactive system 100. For example and not limitation, the detectable objects 105 can include the control panel 120 and a display surface 115 of the display device 110. When an interaction between the input device 200 and a detectable object 105 is detected, the interactive system 100 can determine whether and how to change its state in some manner, thus responding to interactions. Various technologies can be provided in the interactive system 100 to enable detection of the detectable objects 105. For example and not limitation, detectable objects 105 can comprise one of resistive membrane technology, capacitive technology, sensing cameras in proximity to corners of the display device 110, position-coding technology, or some other means for capturing coordinates of the input device 200.

The processing device 140 can be in communication with the input device 200 and can analyze and interpret data received from the input device 200. In some embodiments, the processing device 140 can be an integrated component of the display device 110, but in other embodiments, the processing device 140 can be an external component, for example, a notebook computer or other personal computer.

As mentioned above, the input device 200 can detect its posture during an interaction between the input device 200 and a detectable object 105. This input device 200 can then transmit data describing or representative of the interaction to the processing device 140. The transmitted data describing the interaction can comprise, for example, absolute coordinates on the detectable object 105, relative coordinates based on a prior position of the input device 200, or one or more images captured by the input device 200 of a surface of the detectable object 105.

The processing device 140 can analyze the data received from the input device 200 to determine the posture of the input device 200 with respect to the detectable object 105 and to determine which detectable object 105 was the subject of the interaction with the input device 200. Based on various factors, including, for example, the current state of the interactive system 100, the processing device 140 can interpret the interaction as an operation or an activity selection and can respond accordingly. For example, if indicated by the interaction, the processing device 140 can interpret the input device's movements as drawing or writing on the display surface 115 or as cursor movement across the display surface 115. In that case, the processing device 140 can modify an image projected onto the display surface 115, or render a new image, to account for the interaction. The processing device 140 can then transmit an updated image to the projector 130 for projection onto the display surface 115. To perform one or more of the above operations, the processing device 140 can comprise a computer program product embodied in a computer readable medium or computer storage device. The computer program product can provide instructions for a computer processor to perform some or all the above operations.

The projector 130 can project one or more display images onto the display surface 115. For example and not limitation, the projector 130 can project a graphical user interface or markings created through use of the input device 200. The projector 130 can be in communication with the processing device 140. Such communication can be by means of a wired or wireless connection, Bluetooth, or by many other means through which two devices can communicate. Like the processing device 140, the projector 130 can, but need not, be integrated into the display device 110. Alternatively, the projector 130 can be excluded from the interactive system 100 if the display device 110 is internally capable of displaying markings and other objects on its surface. For example, if the display device 110 is a computer monitor comprising a liquid crystal display, then a separate projector 130 need not be provided.

In some exemplary embodiments of the interactive system 100, the projector 130 can be a short throw or ultra-short throw projector configured to be positioned relatively close to the display device 110 during operation of the interactive system 100. When positioned close to the display device 110, the space between the projector 130 and the display device 110, over which light from the projector 130 can be cast, is less likely to be interrupted by the user of the interactive system 100. Thus, using a short throw projector 130 in the interactive system 100 can enable a user to approach the display device 110 without blocking an image projected onto the display surface 115.

Upon receiving an updated image from the processing device 140, the projector 130 can project the updated image onto the display surface 115. Resultantly, the display surface 115 can display not only physical ink drawn on the display surface 115, but also objects created digitally in response to interactions with the input device 200. Accordingly, the interactive system 100 can cause an operation to be performed on the display surface 115 in accordance with movements of the input device 200. For example and not limitation, markings can be generated in the path of the input device 200, or the input device 200 can direct a virtual cursor across the display surface 115.

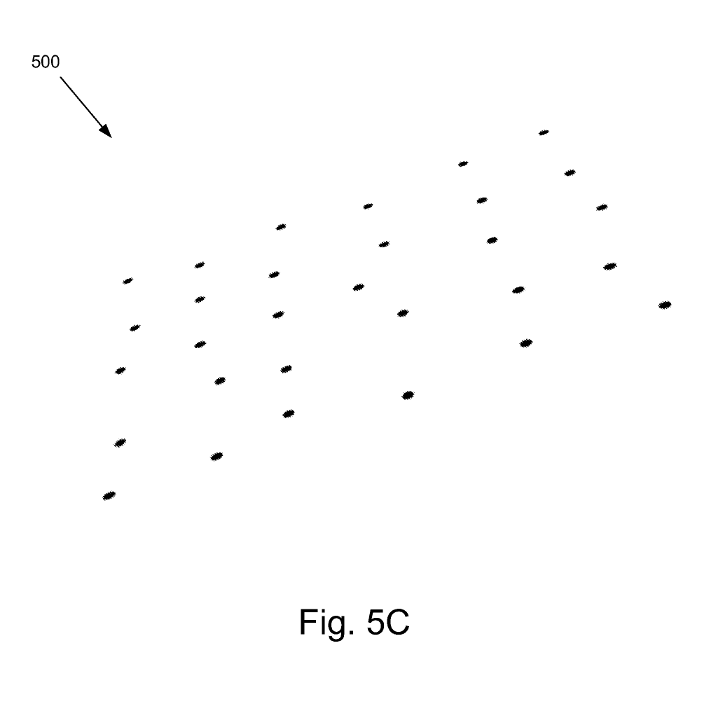

In an exemplary embodiment, the detectable objects 105 can have on their surfaces a position-coding pattern 500, such as the dot pattern illustrated in FIGS. 5A-5C. For example, both the display surface 115 and the control panel 120 can each comprise one or more position-coding patterns 500 or portions thereof. A local portion of the pattern 500 can be detectable by the input device 200, such as by one or more cameras carried by the input device 200, when the input device 200 is used to interact with a detectable object 105. Through analyzing a detected portion of the pattern 500, the input device 200 or the processing device 140 can determine information about the position and orientation of the input device 200 relative to the detectable object 105. Thus, by interpreting detected portions of the pattern 500, the interactive system 100 can determine where on the control panel 120 or display surface 115 the input device 200 is directed, and the interactive system 100 can determine how the input device 200 is moving relative to the control panel 120 or display surface 115.

In an exemplary embodiment of the interactive system 100, the pattern 500 can be such that a detected, local portion of the pattern 500 can indicate absolute coordinates towards which the input device 200 is directed at a given time. For example, if a dot pattern 500 is used, the pattern 500 can be such that the arrangement of dots is unique at each coordinate of a detectable object 105, when viewed at an appropriate distance from the detectable object 105. In a further exemplary embodiment, the portion or portions of the pattern 500 provided on the display surface 115 can differ from the portion or portions on the control panel 120, such that a detected portion of the pattern 500 can indicate not only coordinates on the display surface 115 or the control panel 120, but can also distinguish between the display surface 115 and the control panel 120.

Alternatively to use of a position-coding pattern 500 on the detectable objects 105, other means can also be provided for detecting the input device's posture and movements relative to the detectable objects 105. For example and not limitation, one or more still or video cameras can be provided around the display device 200 or at other locations where interactions would be sufficiently visible to the cameras. The cameras can capture periodic images of the input device 200. Each such image can include a portion of the position-coding pattern, which can be analyzed to determine the postures and movements of the input device 200.

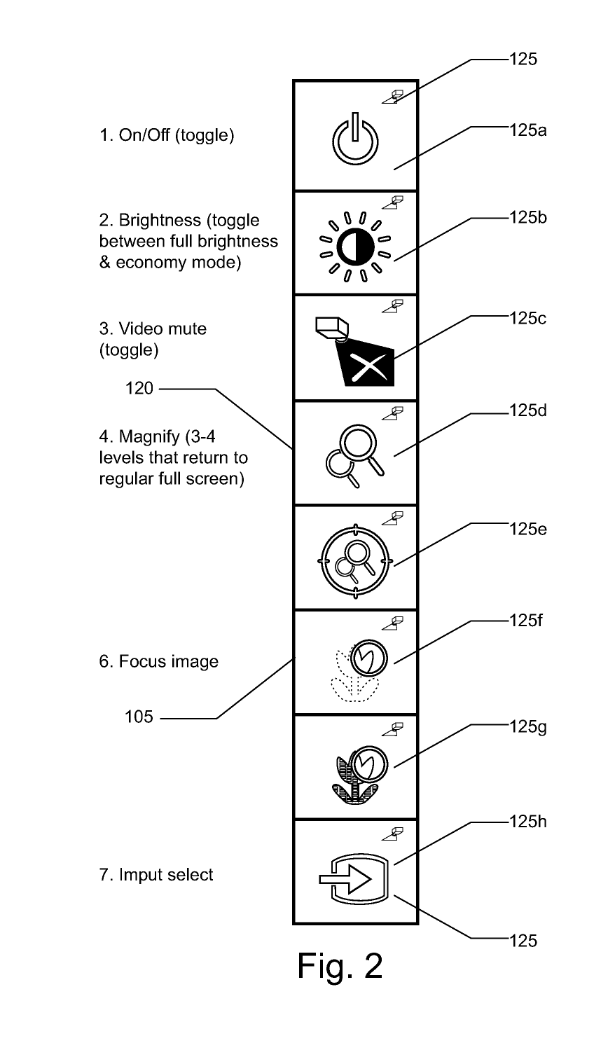

FIG. 2 illustrates a front view of the control panel 120, according to an exemplary embodiment of the present invention. As shown, the control panel 120 can comprise a plurality of activation objects 125, which can each comprise one or more icons, images, or words for ease of recognition by the user. Each activation object 125 can correspond to an activity or function that can be performed by the interactive system 100, and selection of an activation object 125 can initiate the corresponding activity or function.

The interactive system 100 can determine that the user is selecting a particular activation object 125, such as by detecting that the input device 200 is directed at the activation object 125 when in contact with or sufficient proximity to the activation object 125. Detection can be provided by various means including, for example, resistive technology, capacitive technology, triangulation with cameras, or detection of a position-coding pattern 500. The selection of an activation object 125 can be detected when the input device 200 interacts with, e.g., contacts, the activation object 125. According to some exemplary embodiments of the interactive system 100, each activation object 125 can have a corresponding portion of a position-coding pattern 500 on its face. Accordingly, the interactive system 100 can detect when the input device 200 interacts with a particular activation object 125 by detecting the associated, unique portion of the position-coding pattern 500. Such interaction can be interpreted as selection of the activation object 125. When the interactive system 100 determines that an activation object 125 is selected, the interactive system 100 can perform the activity corresponding to the selected activation object 125.

The interactive system 100 can comprise a one or more peripheral hardware devices, including, for example, the projector 130, the processing device 140, an audio system, speakers, HVAC, a disc player, or room lighting. The interactive system 100 can control some aspects of these peripheral devices, and such control can be initiated by selection of applicable activation objects 125. As shown in FIG. 2, various activities corresponding to activation objects 125 can include the following, for example and not limitation: power the projector on or off 125a; adjust brightness of the projector 125b; mute audio 125c; adjust magnification 125d; navigate to center of magnified image 125e; focus projected image 125f and 125g; or select source input 125h. Various other activities and functions besides those illustrated in FIG. 2 can include, for example and not limitation: power on/off or adjust audio system, lighting, HVAC, television, VCR, DVD player, or other peripheral devices; raise or lower a projector 130 screen; open or close blinds; control student assessment devices; or analyze or graph results gathered by student assessment devices. Thus, as in these examples, an activation object 125 can drive various peripherals or control surroundings and devices of the interactive system 100. Activation objects 125 can initiate other activities and functions as well.

In an exemplary embodiment, the control panel 120 and its activation objects 125 can be detectable even when various components of the interactive system 100 are powered down to stand-by or off states. For example, the activation objects 125 can be non-projected, tactile objects that remain visible and selectable when the projector 130 is powered down. While the control panel 120 can be part of or affixed to the display surface 115, as shown in FIG. 1, this need not be the case, and the control panel 120 need not occupy valuable space on the display surface 115. For example, the control panel 120 can be part of or affixed to another section of the display device 110 or a wall. In some embodiments, the control panel 120 can be mobile and releasably securable to various surfaces. For example, the control panel 120 can have a magnetic or adhesive rear surface, such that the control panel 120 can be temporarily affixed to the display device 110 and moved elsewhere as desired.

As mentioned above, the projector 130 need not be powered on for the activation objects 125 to initiate their corresponding activities or functions. Various other components and peripherals of the interactive system 100 can be powered down as well, and the activation objects 125 can continue to drive activities and functions. In some exemplary embodiments, the processing device 140 can be powered on or in a stand-by state, and can be in communication with various other devices associated with the interactive system 100. The processing device 140 can be connected to other devices by, for example, serial cable, Ethernet, USB, Bluetooth, or other wired or wireless connection. Because of the various possible means of connecting devices to the processing device 140, connected devices need not be in the same room or location as the processing device 140, and thus, the activation objects 125 can drive components and peripherals located at remote locations.

When the processing device 140 receives an indication that a particular activation object 125 is selected, which indication can be received from the input device 200, the processing device 140 can transmit a signal to the one or more connected devices needed for the activity or function corresponding to the selected activation object 125. The processing device 140 can transmit a signal, e.g., a series of characters in a TCP/IP command, which can be interpreted by the needed device as a wake-up call to power up the connected device. In some embodiments, the processing device 140 can first detect whether the needed device is already awake, in which case no wake-up command need be sent. Once powered up, the device can receive additional instructions from the processing device 140, the input device 200, or elsewhere, so as to perform operations required of the connected device in the activity or function corresponding to the selected activation object 125.

For example, suppose that the selected activation object 125 corresponds to a command to switch the input source of the projector 130, and further suppose that the projector 130 is powered down when the activation object 125 is selected. When the interactive system 100 detects selection of the activation object 120, the processing device 140 can send a wake-up signal to the projector 130, which can power on in response to the signal. Then, the processing device 140 can transmit to the projector 130 an instruction to change the source input. In response, the projector can change its source input, thus performing the requested activity. As shown by this example, the interactive system 100 can also perform one or more implied intermediate steps when an activation object 125 is selected. For example, if the activity of a selected activation object 125 cannot be performed because a needed device is not turned on, the input device 200 can direct the needed device to power on before the activity is performed.

In some further exemplary embodiments, the input device 200 can be configured to independently recognize activation objects 125, such as by determining coordinates corresponding to the activation objects 125 without needing to transmit data to the processing device 140, and to transmit signals to one or more other electronic components of the interactive system 100 to power the other electronic components on or off as indicated by a selected activation object 125. To this end, the input device 200 can be connected, wired or wirelessly to other devices associated with the interactive system. This input device 200 can thus transmit wake-up commands and other instructions to these connected devices to perform activities or functions requested by way of the activation objects 125, without such commands and instructions needing to pass through the processing device 140. In these embodiments, even if the processing device 140 is powered down, interactions between the input device 200 and the control panel 120 can be recognized and acted upon. For example, if the user selects an activation object 125 corresponding to a request to turn on the interactive system 100, such selection can result in power-on signals being sent to the projector 130, the processing device 140, and other electronic components needed for general operation of the interactive system 100.

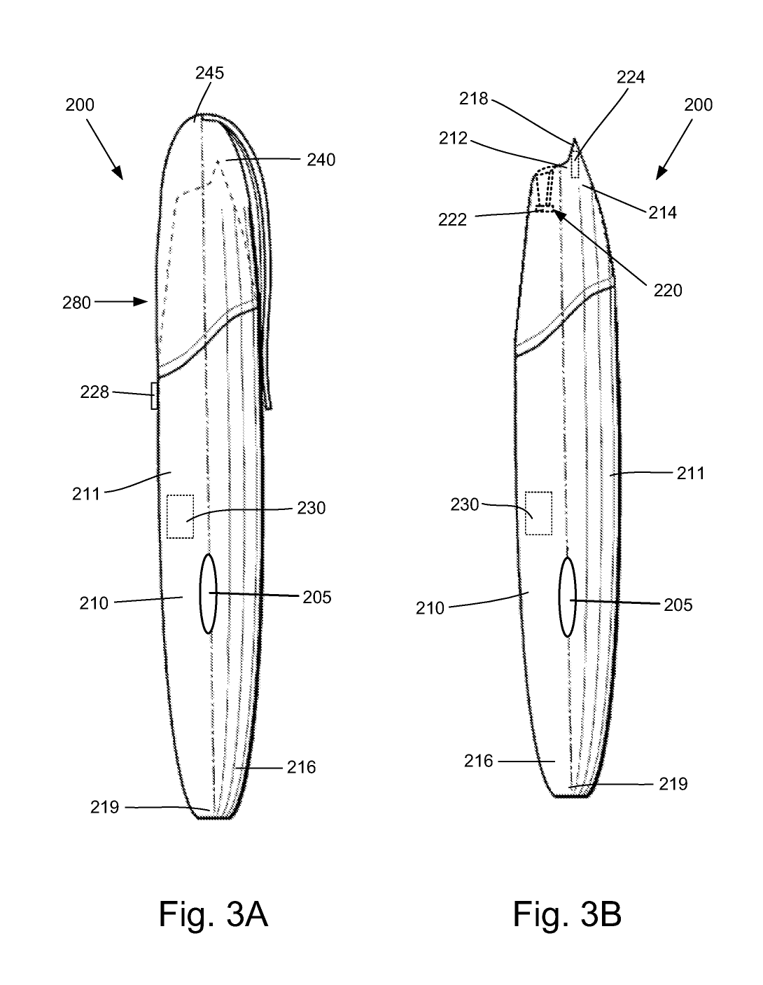

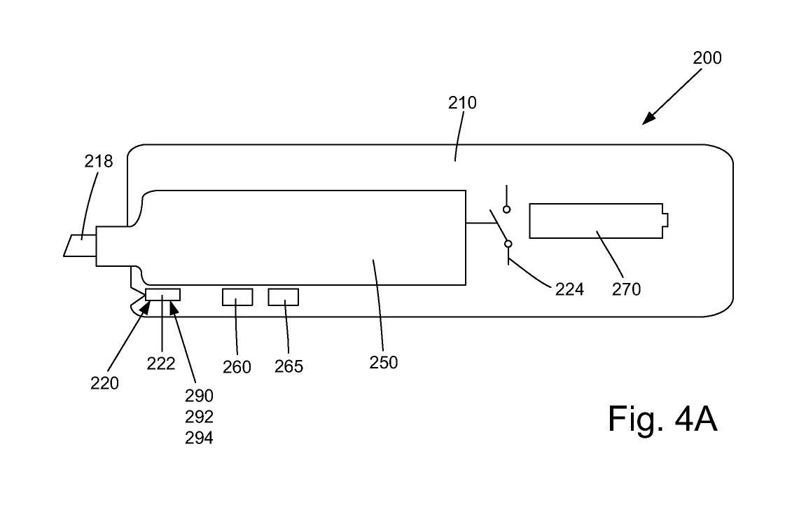

Referring now back to FIG. 1, the input device 200 can be activated by many means, for example, by an actuator 228 (FIG. 3A), such as a switch or button, or by proximity of the input device 200 to the display surface 115. While activated, placement or movement of the input device 200 in contact with, or in proximity to, a detectable object 105 can indicate to the processing device 140 that certain operations are to occur.

When the input device 200 contacts or comes sufficiently close to a detectable object 105, the input device 200 can detect indicia of its posture with respect to the detectable object 105. The indicia detected by the input device 200 can be analyzed by the interactive system 100 to determine a posture of the input device 200 with respect to the detectable object 105. To determine its relative posture, the input device 200 can analyze the detected indicia internally, the input device 200 or can transmit its coordinates or the detected indicia of its coordinates, such as image data, to the processing device 140. The interactive system 100 can interpret the detected data and cause an operation to be performed. If the placement of the input device 200 is interpreted as selection of an activation object 125, the activity corresponding to the selected activation object 125 can be performed. If the placement or movements are interactions with the display surface 115, those movements can indicate, for example, that operations are to occur at the points on the display surface 115 to which the input device 200 is directed.

Through interacting with the display surface 115, the input device 200 can generate markings on the display surface 115, which markings can be physical, digital, or both. For example, when the input device 200 moves across the display surface 115, the input device 200 can leave physical markings, such as dry-erase ink, in its path. The display surface 115 can be adapted to receive such physical markings. For example, and not limitation, the display device 110 can be a whiteboard. Additionally, movement of the input device 200 can be analyzed to create a digital version of such markings. The digital markings can be stored by the interactive system 100 for later recall, such as for emailing, printing, or displaying. The display surface 115 can, but need not, display the digital markings at the time of their generation, such that digital markings generally overlap the physical markings. For example, the processing device 140 can direct the projector 130 to project the digital markings onto the display surface 115 for display.

The complete image displayed on the display surface 115 can comprise both real ink 35 and virtual ink 40. The real ink 35 comprises the markings, physical and digital, generated by the input device 200 and other marking implements. The virtual ink 40 comprises other objects projected, or otherwise displayed, onto the display surface 115. These other objects can include, without limitation, a graphical user interface or windows of an application running on the interactive system 100. Real ink 35 and virtual ink 40 can overlap, and consequently, real ink 35 can be used to annotate objects in virtual ink 40.

FIGS. 3A-3B illustrate partial cross-sectional side views of the input device 200. As shown, the input device 200 can comprise a body 210, a nib 218, a sensing system 220, and a communication system 230.

The body 210 can provide structural support for the input device 200. The body 210 can comprise a shell 211, as shown, to house inner-workings of the input device 200, or alternatively, the body 210 can comprise a primarily solid member for carrying components of the input device 200. The body 210 can be composed of many materials. For example, the body 210 can be plastic, metal, resin, or a combination thereof, or many materials that provide protection to the components or the overall structure of the input device 200. The body 210 can further include a metal compartment for electrically shielding some or all of the sensitive electronic components of the input device 200. The input device 200 can have many shapes consistent with its use. For example, the input device 200 can have an elongated shape, similar to the shape of a conventional writing instrument, such as a pen, or a thicker design, such as a dry-erase marker.

The body 210 can comprise a first end portion 212, which is a head 214 of the body 210, and a second end portion 216, which is a tail 219 of the body 210. The head 214 can be interactable with detectable object 105 during operation of the input device 200.

The nib 218 can be positioned at the tip of the head 214 of the input device 200, and can be adapted to be placed in proximity to, contact, or otherwise indicate, a point on the display surface 115 or control panel 120. For example, as a user writes with the input device 200 on the display surface 115, the nib 218 can contact the display surface 115, as the tip of a pen would contact a piece of paper. In some embodiments, the nib 218 can comprise a marking tip, such as the tip of a dry-erase marker or pen, so that contact of the nib 218 with the display surface 115 can result in physical marking of the display surface 115. Analogously, the user can select an activation object 125 by bringing the nib 218 in contact with, or sufficient proximity to, the activation object 125.

While contact with the display surface 115 or control panel 120 may provide a comfortable similarity to writing with a conventional pen or dry-erase marker, contact of the nib 218 to a detectable object 105 need not be required for operation of the input device 200. For example, once the input device 200 is activated, the user can hover the input device 200 in proximity to the intended detectable object 105, or the user can point from a distance, as with a laser pointer.

The sensing system 220 can be adapted to sense indicia of the posture of the input device 200 with respect to a detectable object 105. In an exemplary embodiment of the interactive system 100, the display surface 115 and the control panel 120 can be detectable objects 105 configured for detection by the input device 200, so the input device 200 can detect its posture relative to these components.

The input device 200 has six degrees of potential movement. In the two-dimensional coordinate system of the display surface 115, the input device 200 can move in the horizontal and vertical directions. The input device 200 can also move normal to the display surface 115, and can rotate about the horizontal, vertical, and normal axes. These rotations are commonly referred to, respectively, as the roll, yaw, and tilt of the input device 200. The term “tipping” as used herein, refers to angling of the input device 200 away from normal to the display surface 115, and, therefore, includes rotations about the horizontal and vertical axes, i.e., the roll and the yaw of the input device 200. On the other hand, “orientation,” as used herein, refers to rotation parallel to the plane of the display surface 115 and, therefore, about the normal axis, i.e., the tilt of the input device 200. The sensing system 220 can sense all, or many combinations of, these six degrees of movement relative to a detectable object 105 by, for example, detecting a local portion of a pattern 500 on the detectable object 105.

As shown, the sensing system 220 can include a first sensing device 222 and a second sensing device 224. Each sensing device 222 and 224 can be adapted to sense indicia of the posture of the input device 200, including various combinations the input device's distance, position, orientation and tipping, with respect to a detectable object 105 within range of the sensing system 220. Further, each sensing device 222 and 224 can individually detect data for determining the posture of the input device 200 or, alternatively, can detect such data in conjunction with other components, such as another sensing device.

The first sensing device 222 can be a surface sensing device for sensing the posture of the input device 200 based on properties of the detectable object 105. The surface sensing device 222 can be or comprise, for example, a camera. The surface sensing device 222 can detect portions of a pattern 500 (see FIGS. 5A-5C) on the display surface 115, such as a dot pattern or a dot matrix position-coding pattern. Detection by the surface sensing device 222 can comprise viewing, or capturing an image of, a portion of the pattern 500. In an alternative exemplary embodiment, the surface sensing device 222 can also or alternatively comprise an optical sensor, such as that conventionally used in an optical mouse. In that case, the surface sensing device 222 can comprise light-emitting diodes and photodiodes, or a CMOS camera, to detect movement relative to the display surface 115. The surface sensing device 222 can be in communication with the body 210 of the input device 200, and can have various positions and orientations with respect to the body 210. For example, the surface sensing device 222 can be housed in the head 214, as shown. Additionally or alternatively, the surface sensing device 222 can be positioned on, or housed in, various other portions of the body 240.

The second sensing device 224 can be a contact sensor. The contact sensor 224 can sense when the input device 200 contacts a surface, such as the display surface 115 or a surface of the control panel 120. The contact sensor 224 can be in communication with the body 210 and, additionally, with the nib 218. The contact sensor 224 can comprise, for example and not limitation, a switch that closes a circuit when a portion of the input device 200, such as the nib 218 contacts a surface with predetermined pressure. Accordingly, when the input device 200 contacts the display surface 115 or the control panel 120, the interactive system 100 can determine that an operation is indicated.

To facilitate analysis of data sensed by the sensing system 220, the input device 200 can further include a communication system 230 adapted to transmit information to the processing device 140 and to receive information from the processing device 140. For example, if processing of sensed data is conducted by the processing device 140, the communication system 230 can transfer sensed data to the processing device 140 for such processing. The communication system 230 can comprise, for example, a transmitter, a receiver, or a transceiver. Many wired or wireless technologies can be implemented by the communication system 230. For example, the communication system 230 can implement Bluetooth or 802.11b technology.

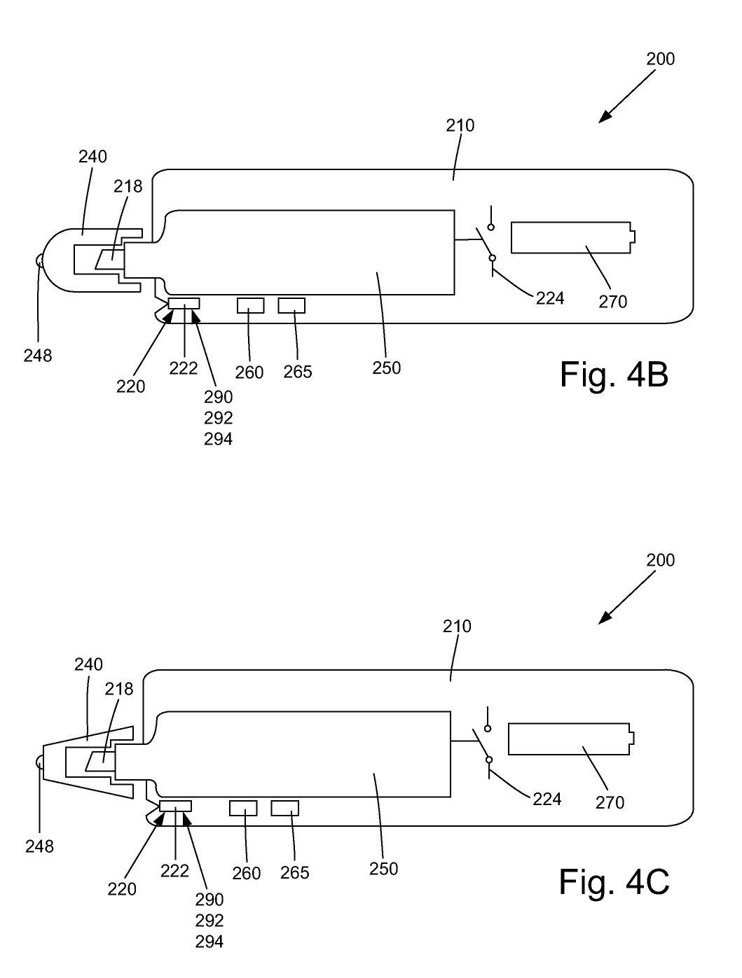

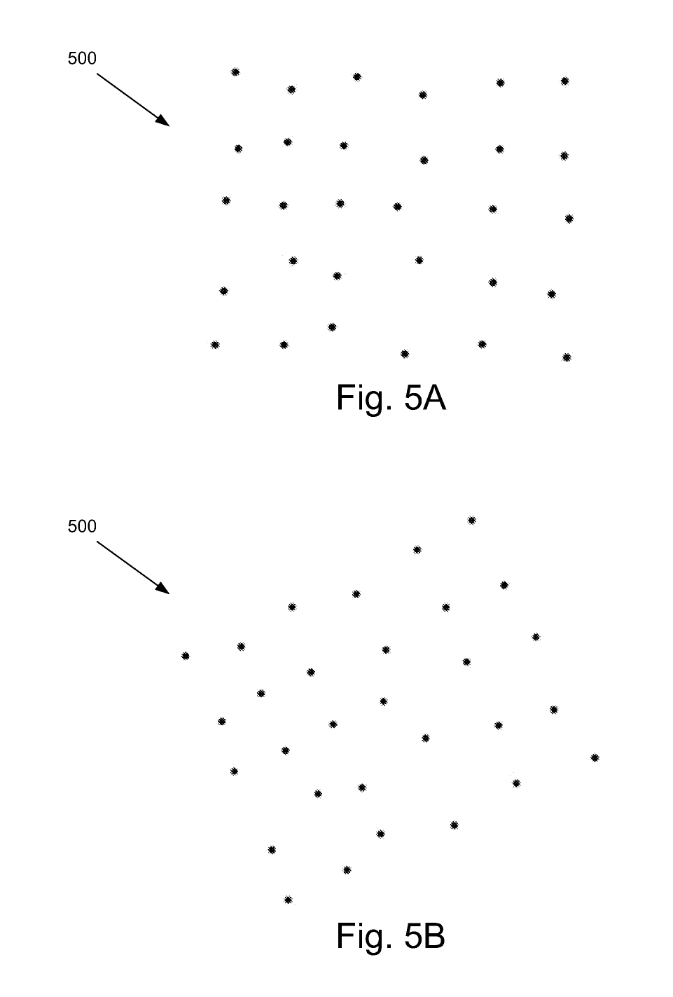

FIGS. 4A-4C illustrate another embodiment of the input device 200. As shown in FIG. 4A, in addition to the above features, the input device 200 can further comprise a marking cartridge 250, an internal processing unit 260, memory 265, a power supply 270, or a combination thereof. The various components can be electrically coupled as necessary.

The marking cartridge 250 can be provided to enable the input device 200 to physically mark the display surface 115. The marking cartridge 250, or ink cartridge or ink well, can contain a removable ink, such as conventional dry-erase ink. The marking cartridge 250 can provide a comfortable, familiar medium for generating handwritten strokes on the display surface 115 while movement of the input device 200 generates digital markings.

The internal processing unit 260 can be adapted to calculate the posture of the input device 200 from data received by the sensing system 220, including determining the relative or absolute position of the input device 200 in the coordinate system of the display surface 115. The internal processing unit 260 can process data detected by the sensing system 220. Such processing can result in determination of, for example: distance of the input device 200 from the display surface 115; position of the input device 200 in the coordinate system of the display surface 115; roll, tilt, and yaw of the input device 200 with respect to the display surface 115, and, accordingly, tipping and orientation of the input device 200.

The memory 265 of the input device 200 can comprise RAM, ROM, or many types of memory devices adapted to store data or software for controlling the input device 200 or for processing data.

The power supply 270 can provide power to the input device 200. The power supply 270 can be incorporated into the input device 200 in any number of locations. If the power supply 270 is replaceable, such as being one or more batteries, the power supply 270 is preferably positioned for easy access to facilitate removal and replacement of the power supply 270. Alternatively, the input device 200 can be coupled to alternate power supplies, such as an adapter for electrically coupling the input device 200 to a car battery, a wall outlet, a computer, or many other power supplies.

Referring back to the sensing system 220, the contact sensor 224, if provided, can detect when a particular portion of the input device 200, such as the nib 218, contacts a surface, such as the display surface 115 or the control panel 120. The contact sensor 224 can be a contact switch, as shown in FIG. 4A, such that when the nib 218 contacts a surface, a circuit closes to indicate that the input device 200 is in contact with the surface. The contact sensor 224 can also be a force sensor, which can detect whether the input device 200 presses against the surface with a light force or a hard force. The interactive system 100 can react differently based on the degree of force used. For example, if the force is applied to the display surface 115 and is below a certain threshold, the interactive system 100 can recognize that the input device 200 drives a cursor. On the other hand, when the force on the display surface 115 or on a particular activation object 125 is above a certain threshold, which can occur when the user presses the input device 200 to the board, the interactive system 100 can register a selection, similar to a mouse click. Further, the interactive system 100 can vary the width of markings projected onto the display surface 115 based on the degree of force with which the input device 200 contacts the display surface 115.

The surface sensing device 222 can include, for example, a complementary metal oxide semiconductor (CMOS) image sensor, a charge-coupled device (CCD) image sensor, or many other types of sensors for receiving image information. The surface sensing device 222 can be a CMOS or CCD image-sensor array having a size of, for example, 128 by 100, 128 by 128, or larger. The surface sensing device 222 can capture images of the pattern 500 on detectable objects 105 as the pen is moved, and through image analysis, the interactive system 100 can detect the posture and movement of the input device 200 with respect to the detectable objects 105 captured.

A detectable object 105 can include many types of image data indicating relative or absolute positions of the input device 200 in the coordinate system of the detectable object 105. For example, the detectable object 105 can comprise a known image, which can include alphanumeric characters, a coding pattern, or many discernable patterns of image data capable of indicating relative or absolute position. The implemented pattern can indicate either the position of the input device 200 relative to a previous position, or can indicate an absolute coordinates.

Determining a point on a detectable object 105 indicated by the input device 200 can require determining the overall posture of the input device 200. The posture of the input device 200 can include the position, orientation, tipping, or a combination thereof, of the input device 200 with respect to the display surface 115. When the input device 200 is sufficiently close to the detectable object 105, it may be sufficient to determine only the position of the input device 200 in the two-dimensional coordinate system of the surface of the detectable object 105. When the input device 200 is farther away, as when pointing from across the room, the orientation and tipping of the input device 200 can be required to determine an indicated point on the detectable object 105.

Various detection systems can be provided in the input device 200 for detecting the posture of the input device 200. For example, a tipping detection system 290 can be provided in the input device 200 to detect the angle and direction at which the input device 200 is tipped with respect to the detectable object 105. An orientation detection system 292 can be implemented to detect rotation of the input device 200 in the coordinate system of the detectable object 105. Additionally, a distance detection system 294 can be provided to detect the distance of the input device 200 from the detectable object 105.

These detection systems 290, 292, and 294 can be incorporated into the sensing system 220. For example, the position, tipping, orientation, and distance of the input device 200 with respect to the display surface 115 can be determined, respectively, by the position, skew, rotation, and size of the appearance of the pattern 500 on the detectable object 105, as viewed from the surface sensing device 222. For example, FIGS. 5A-5C illustrate various views of an exemplary dot pattern 500 on a detectable object 105, such as the display surface 115 of the control panel 120. The dot pattern 500 serves as a position-coding pattern in the interactive system 100.

FIG. 5A illustrates an image of an exemplary position-coding pattern 500, which is considered a dot pattern. It is known that certain dot patterns can provide indication of absolute coordinates and can thus indicate specific points on the display surface 115 or specific activation objects 125. In the image of FIG. 5A, the dot pattern 500 is viewed at an angle normal to the detectable object 105. This is how the dot pattern 500 could appear from the surface sensing device 222, when the surface sensing device 222 is directed normal to the detectable object 105. In the image, the dot pattern 500 appears in an upright orientation and not angled away from the surface sensing device 222. As such, when the surface sensing device 222 captures such an image, the interactive system 100 can determine that the input device 200 is normal to the detectable object 105 and therefore points approximately directly into the detectable object 105.

As the input device 200 moves away from the detectable object 105, the size of the dots and the distance between the dots in the captured image decreases. Analogously, as the input device 200 moves toward the detectable object 105, the size of the dots and the distance between the dots appears to increase. As such, in addition to sensing the tipping and orientation of the input device 200, the surface sensing device 222 can sense the distance of the input device 200 from the detectable object 105.

FIG. 5B illustrates a rotated image of the dot pattern 500. A rotated dot pattern 500 indicates that the input device 200 is rotated about a normal axis of the detectable object 105. For example, when a captured image depicts the dot pattern 500 rotated at an angle of 30 degrees clockwise, it can be determined that the input device 200 is oriented at an angle of 30 degrees counter-clockwise. As with the image of FIG. 5A, this image was taken with the surface sensing device 222 oriented normal to the detectable object 105, so even though the input device 200 is rotated, the input device 200 still points approximately directly into the detectable object 105.

FIG. 5C illustrates a third image of the dot pattern 500 as viewed by the surface sensing device 222. The flattened image, depicting dots angled away from the surface sensing device 222, indicates that the surface sensing device 222 is not normal to the detectable object 105. Further, the rotation of the dot pattern 500 indicates that the input device 200 is rotated about the normal axis of the detectable object 105 as well. The image can be analyzed to determine the tipping angle and direction as well as the orientation angle. For example, it may be determined that the input device 200 is tipped downward 45 degrees, and then rotated 25 degrees. These angles determine to which point on the detectable object 105 the input device 200 is directed.

Accordingly, by determining the angles at which an image received from the surface sensing device 222 was captured, the interactive system 100 can determine points indicated by the input device 200.

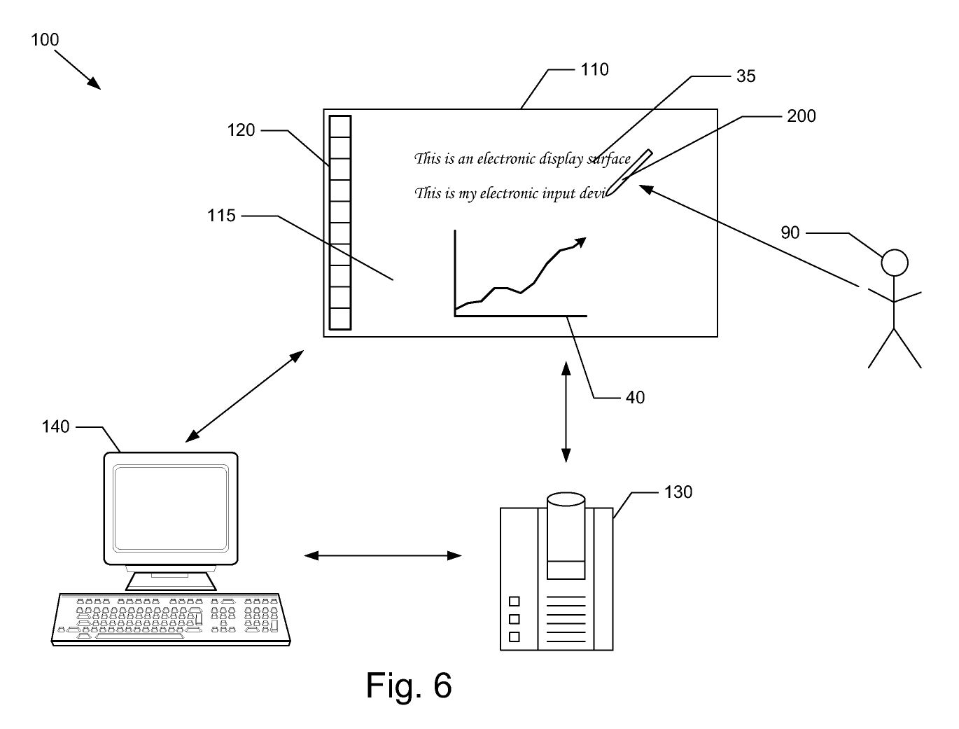

FIG. 6 illustrates a use of the input device 200 in conjunction with the display surface 115, according to an exemplar embodiment of the present invention. At a moment in time, the display surface 115 can display an image communicated from the processing device 140. If a projector 130 is provided, a portion of such image can be communicated from the processing device 140 to the projector 130, and then projected by the projector 130 onto the display surface 115. The display image can include real ink 35, such as physical and digital markings produced by the input device 200, as well as virtual ink 40.

In an exemplary embodiment, a user 90 can initiate further marking by bringing a portion of the input device 200 in sufficient proximity to the display surface 115, or by placing a portion of the input device 200 in contact with the display surface 115. To mark the display surface 115 in marking mode, the user 90 can move the input device 200 along the display surface 115. This movement can result in real ink 35, which can be represented digitally and physically on the display surface 115. Alternatively, in pointing mode, movement of the input device 200 along the surface 115 can result in, for example, movement of a cursor. Such movement can be similar to movement of a mouse cursor across a graphical user interface of a personal computer.

As the input device 200 travels along the display surface 115, the sensing system 220 continuously or periodically senses data indicating the changing posture of the input device 200 with respect to the display surface 115. This data is then processed by the interactive system 100. In one embodiment, the internal processing unit 260 of the input device 200 processes the data. In another embodiment, the data is transferred to the processing device 140 by the communication system 230 of the input device 200, and the data is then processed by the processing device 140. Processing of such data can result in determining the posture of the input device 200 and, therefore, can result in determining areas of the display surface 115 on which to operate. If processing occurs in the internal processing unit 260 of the input device 200, the results are transferred to the processing device 140 by the communication system 230.

Based on determination of relevant variables, the processing device 140 can produce a revised image to be displayed onto the display surface 115. In marking mode, the revised image can incorporate a set of markings not previously displayed, but newly generated by use of the input device 200. Alternatively, the revised image can be the same as the previous image, but can appear different because of the addition of physical markings. Such physical markings, while not necessarily projected onto the display surface 115, are recorded by the processing device 140.

In pointing mode, the revised image can incorporate, for example, updated placement of the cursor. The display surface 115 is then refreshed, which can involve the processing device 140 communicating the revised image to the optional projector 130. Accordingly, operations and digital markings indicated by the input device 200 can be displayed through the interactive system 100. In one embodiment, this occurs in real time.

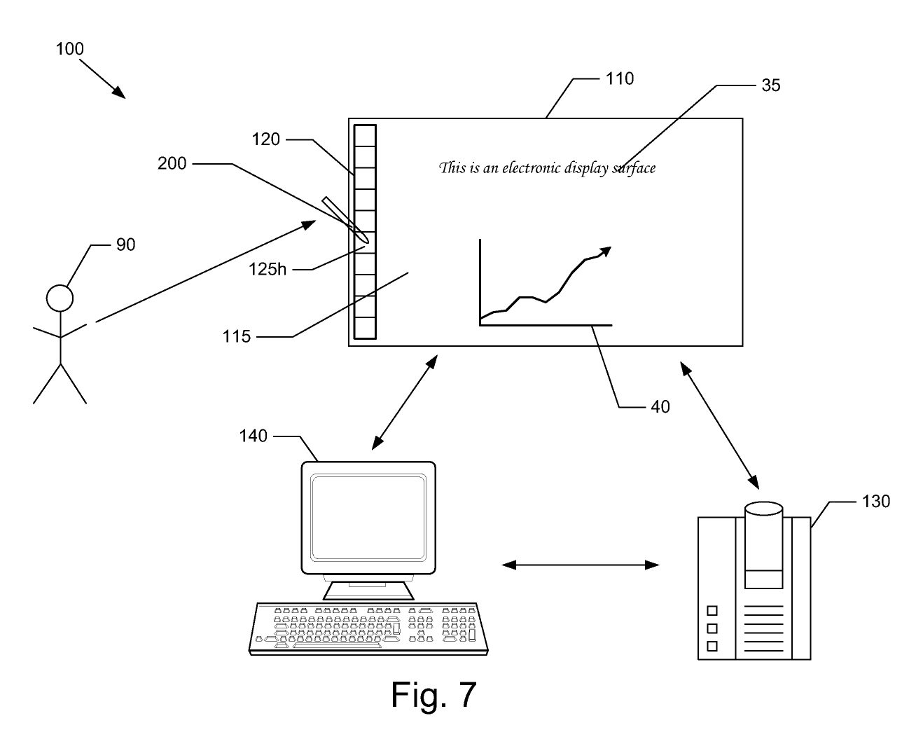

FIG. 7 illustrates a use of the input device 200 in conjunction with the control panel 120, according to an exemplary embodiment of the present invention. The user 90 can initiate performance of an activity by selecting an activation object 125 on the control panel 120. Such selection can be performed by, for example, the user's touching the nib 218 of the input device 200 to the desired activation object 125, or by the user's pointing the input device 200 at the activation object 125.

The input device 200 can continuously or periodically sense data, such as image data, indicating the changing posture of the input device 200 with respect to any detectable objects 105 in view of the sensing system 220. When the user 90 selects the desired activation object 125, the input device 200 can capture a portion of the pattern 500 on the selected activation object 125. In some exemplary embodiments, the interactive system 100 can then calculate absolute coordinates corresponding to the captured image of the pattern 500. Because the portions of the pattern 500 on each activation object 125 differ from one another and from the portion of the pattern 500 on the display surface 115, the interactive system 100 can map the calculated coordinates of the captured image to a particular activation object 125. After the selected activation object 125 is identified, the interactive system 100 can perform the activity corresponding to the selected activation object 125.

For example, the user 90 can select an activation object 125h corresponding to a request to change the source input of the projector 130. When the user 90 contacts the activation object 125 with the input device 200, or points the input device 200 at the activation object 125 in sufficient proximity to the activation object 125, the interactive system 100 can detect the selection and identity of the activation object 125. As discussed above, in some embodiments, this detection can occur when the input device 200 captures an image of a local portion of a pattern 500 on the surface of the activation object 125. The image can be transmitted to the processing device 140, which can resolve the image to a set of absolute coordinates and can identify the absolute coordinates as corresponding to the selected activation object 125.

After detecting selection of the activation object 125 and identifying the particular activation object 125 selected, the interactive system 100 can proceed to perform the activity corresponding to the activation object 125, in this example, changing the source input of the projector 130. The processing device 140 can transmit a signal to the projector, instructing the projector 130 to change to another source input. Accordingly, the activity corresponding to the selected activation object 125 can be performed in response to the user's selection of the activation object 125.

While various embodiments of the interactive system have been disclosed in exemplary forms, many modifications, additions, and deletions can be made without departing from the spirit and scope of the invention and its equivalents, as set forth in claims to be filed in a later non-provisional application.

What is claimed is:

1. A presentation system comprising:
a processing device;
one or more activation objects, each activation object comprising a corresponding position-coding pattern and each activation object being mapped to a corresponding activity; and
a detection system configured to detect the position-coding pattern on an activation object with which an input device interacts, and to identify selection of a first activation object based on detection of a first position-coding pattern corresponding to the first activation object;
the processing device being further configured to transmit to one or more peripheral devices one or more instructions for performing the activity corresponding to the first activation object, in response to selection of the first activation object.

2. The presentation system of claim 1, the processing device or the input device being configured to map the first position-coding pattern to one or more coordinates.

3. The presentation system of claim 1, the processing device configured to receive indicia of the first activation object from the input device.

4. The presentation system of claim 3, the input device comprising an image-capture device for capturing an image of at least a portion of the position-coding pattern on the first activation object.

5. The presentation system of claim 4, the processing device or the input device being configured to map the portion of the position-coding pattern to the first activation object.

6. The presentation system of claim 3, the processing device being integrated into the input device.

7. The presentation system of claim 1, further comprising:
a display device having a display surface; and
a projector for projecting an image onto the display surface;
wherein the first activation object corresponds to a command to adjust one or more settings of the projector, and wherein the processing device transmits a signal to the projector in response to selection of the first activation object.

8. The presentation system of claim 7, the first activation object corresponding to a command to power on the projector.

9. The presentation system of claim 1, further comprising a display device having a display surface, the display surface having a second position-coding pattern thereupon, wherein the detection system is further configured to distinguish interactions between the input device and the display surface from interactions between the input device and the activation objects.

10. The presentation system of claim 9, the detection system being configured to determine coordinates on the display surface at which an interaction between the input device and the display surface occurs, based on detection of the second position-coding pattern.

11. The presentation system of claim 9, the activation objects being releasably securable to the display surface.

12. The presentation system of claim 9, the activation objects being integrated into the display device.

13. The presentation system of claim 1, at least one of the peripheral devices belonging to a group consisting of a projector, an audio system, a lighting system, HVAC, a disc player, and an automated projector screen.

14. The presentation system of claim 1, the first position-coding pattern comprising a pattern of dots.

15. A presentation system comprising:
a display device having a display surface with a first position coding pattern;
a peripheral device;
an activation object having a second position coding pattern, the activation object being associated with a first command related to the peripheral device;
an input device for detecting a local position-coding pattern indicating a current posture of the input device with respect to an object comprising the local position-coding pattern; and
a processing system configured to receive indicia of the current posture of the input device and, if the indicia indicates selection of the activation object, to transmit an instruction to the peripheral device to execute the first command.

16. The presentation system of claim 15, the processing system being external to the input device.

17. The presentation system of claim 15, the input device comprising an image capture device for capturing one or more images of the local position-coding pattern.

18. The presentation system of claim 15, the activation object being a non-projected object.

19. The presentation system of claim 15, the activation object being a tangible object.

20. A method comprising:
providing one or more activation objects and one or more position-coding patterns, each activation object having a corresponding position-coding pattern, and each activation object being associated with a corresponding command related to one or more hardware devices;
detecting a posture of an input device with respect to the activation objects, based on detection of at least one of the position-coding patterns;
identifying selection of a first activation object based on the posture of the input device; and
transmitting an instruction to at least one of the hardware devices to comply with the command associated the first activation object, in response to the selection of the first activation object.

21. The method of claim 20, wherein detecting a posture of the input device with respect to the activation objects comprises capturing an image of the at least one of the position-coding patterns.

22. The method of claim 20, the activation objects being tangible objects.

23. The method of claim 22, wherein transmitting the instruction to at least one of the hardware devices comprises transmitting the instruction to a projector to power on the projector.

24. The method of claim 20, wherein transmitting the instruction to at least one of the hardware devices comprises transmitting the instruction to at least one of a group consisting of a projector, an audio system, a lighting system, HVAC, a disc player, and an automated projector screen.

25. The method of claim 20, further comprising providing a display device having a display surface with a corresponding position-coding pattern.

26. The method of claim 25, further comprising determining toward which of the display surface and the first activation object the input device is directed.
